(19) United States
(12) Patent Application Publication
(10) Pub. No.: US 2012/0154092 A1
(43) Pub. Date: Jun. 21, 2012

(54) Apparatus and Associated Methods

(75) Inventors: Eira Tuulia SEPPALA, Helsinki (FI); Markku Anttoni Oksanen, Helsinki (FI); Vladimir Alexsandrovich Ermolov, Espoo (FI); Aarno Parssinen, Espoo (FI)

(73) Assignee: Nokia Corporation

(21) Appl. No.: 12/971,789

(22) Filed: Dec. 17, 2010

(51) Int. Cl. H01F 5/00; H01F 41/04; H01F 17/04

(52) U.S. Cl. 336/177; 29/606

(57) ABSTRACT

An apparatus including a coil configured to allow a flow of electrical current therethrough to generate a magnetic field, and a composite material configured to increase the strength of the magnetic field relative to that which could be generated by the coil without the composite material, the composite material including a plurality of magnetic particles having a mean maximum dimension of less than 100 nm dispersed within a dielectric binder.

### TECHNICAL FIELD

The present disclosure relates to the field of electromagnetic coils, associated methods and apparatus, and in particular concerns the use of a composite material to increase the inductance of a coil without increasing the magnetic or dielectric losses. Certain disclosed example aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Inductors are used extensively in analogue circuits and signal processing. When used in conjunction with capacitors and other electrical components, inductors form tuned circuits which can emphasise or filter out specific signal frequencies. Applications range from the use of large inductors in power supplies, which in combination with capacitors can be used to remove residual hums or other fluctuations from the direct current output, to the small inductance of the ferrite bead or torus installed around a cable to prevent radio frequency interference from being transmitted down the wire. Small inductor/capacitor combinations provide tuned circuits used in the transmission and reception of radio frequency (RF) signals.

When used in RF applications, inductors can provide high performance at relatively low power consumption. However, inductors are considerably larger in size than most other integrated components, which inhibits device miniaturisation and places restrictions on design freedom. For this reason, many manufacturers prefer to use coil-less design styles which are more compact but less efficient.

To reduce the physical size of inductors, some manufacturers have tried incorporating high permeability materials. Such materials increase the magnetic flux through the coil, which allows the coil to be reduced in size whilst retaining a comparable induction. However, at high frequencies (particularly radio frequencies), inductors made from these materials suffer from increased resistance and other losses. In resonant circuits, this can reduce the Q-factor of the circuit and broaden the bandwidth of operation. This is a particular problem for frequencies above 1 GHz if the loss is not tolerated by the application.

The apparatus and associated methods disclosed herein may or may not address this issue.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided an apparatus configured to allow a flow of electrical current therethrough to generate a magnetic field, and a composite material configured to increase the strength of the magnetic field relative to that which could be generated by the coil without the composite material, the composite material comprising a plurality of magnetic particles having a mean maximum dimension of less than 100 nm dispersed within a dielectric binder.

The term “magnetic field” may be used interchangeably with the term “magnetic induction”.

The plurality of magnetic particles may have a distribution of sizes within the dielectric binder. The maximum dimension of each particle may vary from the mean by up to 10 nm, 20 nm, 30 nm, 40 nm or 50 nm. The mean maximum dimension may be up to 10 nm, 10-20 nm, 20-30 nm, 30-50 nm, or 50-100 nm. The magnetic particles may have a mean maximum dimension of less than or equal to 20 nm. The magnetic particles may have a mean maximum dimension of between 20 nm and 100 nm exclusive. The magnetic particles may be substantially spherical in shape, in which case, the maximum dimension may be the particle diameter.

The magnetic particles may be ferromagnetic or superparamagnetic particles. The magnetic particles may comprise one or more of Fe, Co, Ni, FePt and Fe₃O₄. The dielectric binder may comprise a non-polar polymer. The dielectric binder may comprise one or more of polystyrene, syndiotactic polystyrene, polyethylene, polypropylene, cyclic olefin copolymer, polyisobutylene, polyisoprene, polybutadiene, polytetrafluoroethylene, fluorinated ethylene propylene, polyvinylidene fluoride, and any copolymer or polymer blend comprising the monomers of these polymers.

The composite material may comprise a surfactant configured to reduce the mobility of the magnetic particles within the dielectric binder. The surfactant may be configured to interact with the dielectric binder through one or more of Van der Waals forces, electrostatic forces, and covalent binding. The surfactant may comprises a head group configured to adsorb onto the surface of the magnetic particles. The head group may comprise an amine, carboxylic acid, or silane group.

The magnetic particles may exhibit a substantially uniform concentration within the dielectric binder. The magnetic particles may exhibit a concentration gradient within the dielectric binder.

The apparatus may be configured to pass an AC current through the coil at a frequency of interest. The frequency of interest may be no less than 0.01 GHz.

The composite material may have, at the frequency of interest, one or more of the following: a relative magnetic permeability of no less than 1.0, a loss tangent of relative magnetic permeability of no greater than 0.1, a relative dielectric permittivity of no greater than 4.0, and a loss tangent of relative permittivity of no greater than 0.1. The loss tangent of relative permittivity may be less than or equal to 0.01.

The composite material may form a coating on all or part of the coil. The composite material may form a core around which the coil is wound.

The apparatus may be one or more of the following: an inductor, a transformer, an electromagnet, a balun, an unun, a choke, and any other multiwinding magnetic component.

According to a further aspect, there is provided a device comprising any apparatus described herein. The device may be one or more of the following: an electronic device, a portable electronic device, a portable telecommunications device, and a module for any of the aforementioned devices.

According to a further aspect, there is provided a method of making an apparatus, the method comprising:
providing a coil configured to allow a flow of electrical current therethrough to generate a magnetic field; and
providing a composite material configured to increase the strength of the magnetic field relative to that which could be generated by the coil without the composite material, the composite material comprising a plurality of magnetic particles having a mean maximum dimension of less than 100 nm dispersed within a dielectric binder.

According to a further aspect, there is provided a method of generating a magnetic field, the method comprising:
providing an apparatus, the apparatus comprising a coil configured to allow a flow of electrical current therethrough to generate a magnetic field, and a composite material configured to increase the strength of the magnetic field relative to that which could be generated by the coil without the composite material, the composite material comprising a plurality of magnetic particles having a mean maximum dimension of less than 100 nm dispersed within a dielectric binder; and
passing an electrical current through the coil.

The steps of any method disclosed herein do not have to be performed in the exact order disclosed, unless explicitly stated or understood by the skilled person.

According to a further aspect, there is provided a computer program, recorded on a carrier, the computer program comprising computer code configured to perform any method described herein for making the apparatus.

According to a further aspect, there is provided a computer program, recorded on a carrier, the computer program comprising computer code configured to perform any method described herein for generating a magnetic field.

The apparatus may comprise a processor configured to process the code of the computer program. The processor may be a microprocessor, including an Application Specific Integrated Circuit (ASIC).

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1 shows a standard inductor;

FIG. 2 shows a typical hysteresis loop for a ferromagnetic material;

FIG. 3 shows a typical magnetisation reversal process for a rectangular piece of ferromagnetic material;

FIG. 4 shows a composite material comprising a uniform distribution of magnetic particles within a dielectric binder;

FIG. 5a shows the typical domain process of a ferromagnetic particle under the influence of an applied magnetic field;

FIG. 5b shows the typical hysteresis loop of a ferromagnetic particle;

FIG. 6a shows rotation of the magnetisation in a superparamagnetic particle under the influence of an applied magnetic field;

FIG. 6b shows the typical hysteresis loop of a superparamagnetic particle;

FIG. 7 shows a composite material comprising a non-uniform distribution of magnetic particles within a dielectric binder;

FIG. 8 shows a plurality of surfactant molecules adsorbed onto the surface of a magnetic particle;

FIG. 9 shows a device comprising the apparatus described herein;

FIG. 10 shows a method of making the apparatus described herein;

FIG. 11 shows a method of using the apparatus described herein; and

FIG. 12 shows a computer readable medium providing a program for controlling the making and/or use of the apparatus described herein.

### DESCRIPTION OF SPECIFIC ASPECTS/EMBODIMENTS

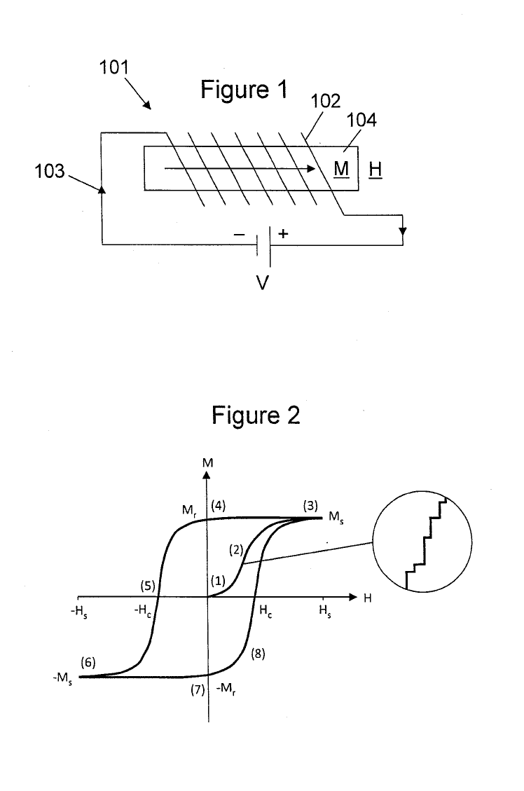

With reference to FIG. 1, an inductor 101 is a passive electrical component that can store energy in a magnetic field. An inductor's ability to store magnetic energy is measured by its inductance, in units of henries. In its simplest form, an inductor 101 comprises a length of electrically conducting wire 102 wound as a coil. According to Ampere's law, a magnetic field is generated inside the coil 102 when an electrical current 103 is passed through the wire 102. As a result of the time-varying magnetic field inside the coil 102, a voltage or electromotive force (EMF) is induced (Faraday's law) which opposes the change in current 103 that created the magnetic field (Lenz's law).

Inductance is a measure of the amount of EMF generated per unit change in current. The number of turns of wire 102, the size of each turn, and the material 104 that the wire 102 is wound around all affect the inductance. The magnetic field strength (magnetic flux) can be increased if a “core” of magnetic material 104 (with a relative magnetic permeability greater than 1) is placed inside the coil 102. In this scenario, the magnetic material's magnetisation contributes to the magnetic induction in addition to the field generated by the flow of current 103. The term “air core” is used to describe an inductor 101 that does not use a core of magnetic material 104.

Ferromagnetic materials are normally used to form the core of an inductor. Ferromagnetic materials are composed of small regions of uniform magnetisation called magnetic domains which act like tiny bar magnets, each with its own magnetic moment (field). Before a current is passed through the coil, the domains in the core point in different directions and the magnetic moments cancel each other out. As a result, the core has little net magnetisation. When a current is passed through the coil, however, the magnetic field generated by the flow of current in the wire penetrates the core and aligns the magnetic moment of each domain parallel to the field direction. In this way, the magnetisation of the core adds to the field from the coil to create a stronger magnetic field. The larger the current passed through the coil, the more the domains will align with the field. Once all of the domains are aligned, the magnetic material is said to be saturated. At this point, any further increase in the current will only cause a slight increase in the magnetic field strength.

As mentioned in the background section, existing inductors suffer from higher resistance and losses when operated at high frequencies. A major source of loss in inductors is hysteresis in the magnetic material.

The magnetisation of ferromagnetic materials depends not only on the applied field, but also on the previous magnetic history. This behaviour is called hysteresis. The macroscopic field response is considered first and is depicted in FIG. 2. If we take an isotropic ferromagnetic material in the as-grown state, where the sample has never been exposed to an external field, the domains within the material will be arranged such that the net magnetisation is zero (1). By then applying a field, a net magnetisation is induced in the field direction (2). As this field is increased, the magnetisation increases until saturation, Mₛ (3), when all the moments are aligned with the applied field, Hₛ. When this field is removed, the magnetisation then drops to a value known as the remanant magnetisation (or remanance), Mᵣ (4). The remanent magnetisation can range from zero to near Mₛ depending on the material. A field applied in the opposite direction will then reduce the magnetisation to zero (5) with the field strength at which this occurs known as the coercive field, H_{c} (or the coercivity). Increasing the negative field saturates the magnetisation in the opposite direction (6) before field removal allows the system to reach remanance again (7). Application of a positive field then demagnetises the sample as before (8). The M-H graph produced as the field is swept between positive and negative values is known as a hysteresis loop. The area of the loop is a measure of the work required to take the material through one complete magnetisation cycle. Note, however, that the initial increase of the magnetisation from zero to Mₛ between field values of zero and Hₛ (1)-(3) is never repeated. This type of hyteresis loop is called a major loop since the magnetisation is driven between saturation in opposite directions. On the other hand, cycling between smaller field values results in minor loops of which there can be an infinite amount.

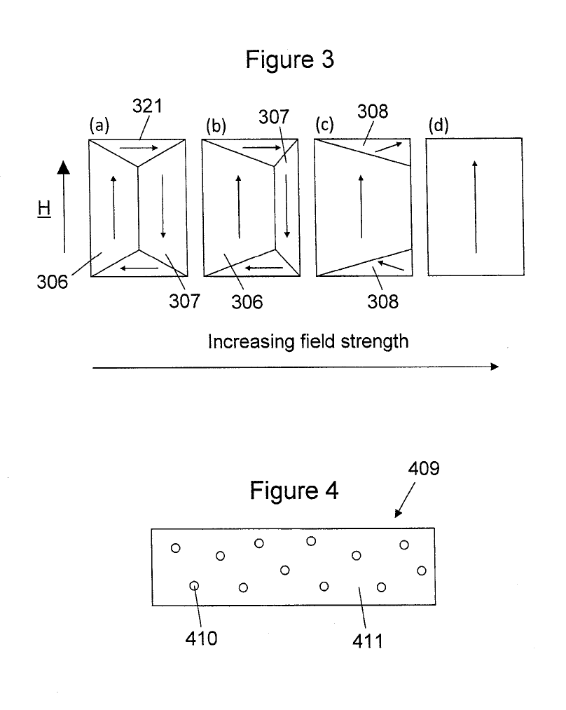

When an external field is applied, the magnetisation can change direction to align with the field in two different ways. One mechanism is coherent rotation. In this situation, the magnetisation vector rotates smoothly from one direction to the other and occurs in films possessing uniaxial anisotropy. However, in larger systems it may be more energetically favourable for reversal to occur through domain processes. This mechanism involves the nucleation of domain walls and subsequent domain wall motion, and is shown in FIG. 3. Domain walls 305 are the boundaries between adjacent domains 306, 307. Within the wall 305, the magnetic moments of the material rotate smoothly between the two directions of magnetisation. By considering a rectangular piece of ferromagnetic material 321 exhibiting an initial flux closure state (FIG. 3a) and applying a field parallel to the long axis, the domain 306 aligned with the field increases in size at the expense of the others (FIG. 3b). This process is reversible. As the field is increased, however, domain wall annihilation occurs and the domain 307 unfavourably aligned with the field is removed (FIG. 3c). This is an irreversible step. Domains 308 oriented close to the applied field direction rotate to align with the field. At larger fields, further domain wall annihilation occurs and a single-domain state is reached (FIG. 3d). In general, the growth and reduction of domains are reversible processes, whilst domain wall annihilation is irreversible. It is the irreversible steps that are responsible for hysteresis in ferromagnetic materials. In addition, the small magnetisation jumps that occur in hysteresis loops (Barkhausen effect) are due to irreversible domain wall motion (see expanded section of FIG. 2). The energy loss is proportional to the area of the hysteresis loop. Materials with a low coercivity have a narrow hysteresis loop and therefore exhibit low hysteresis losses.

The energy loss due to hysteresis is also frequency dependent. When an alternating magnetic field (as is the case with AC inductors) is applied at low frequencies, the magnetic domains respond to the field and produce a high permeability material. At low frequencies, the permeability is high because the domains can follow the applied field. As the frequency increases, however, the domains lag behind the applied field causing a loss in energy due to friction. This energy loss results in a decrease in the material's permeability. At very high frequencies, the domains cannot follow the applied field, and so there is no frictional loss.

A second source of energy loss in inductors is eddy currents. The changing magnetic field induces circulating loops of electrical current in the conductive metal core, and the energy in these currents is dissipated as heat by resistance of the core material. The amount of energy lost increases with the area inside the loop of current. For eddy currents, the energy loss per cycle of alternating current is constant, so core losses increase linearly with frequency.

Another problem with inductors is parasitic capacitance. In order to prevent adjacent turns of wire from short-circuiting the inductor, the wire of the coil needs to be coated by an electrically insulating material. However, because each turn of the coil is at a slightly different potential and the adjacent turns are separated by a thin layer of dielectric, an electric field exists between the turns which stores charge on the wire. As a result, the coil acts as though it has a capacitor in parallel with it. At a high enough frequency (the self-resonant frequency), the capacitance resonates with the inductance of the coil to form a tuned circuit. An inductor behaves ideally only when its working frequency is well below the self-resonant frequency. As its working frequency increases, the effects of parasitic capacitance become more pronounced until its effective inductance is eventually cancelled by its capacitive counterpart. The effects of parasitic capacitance are made worse when the dielectric material used to insulate the coil has a high dielectric constant (or high relative dielectric permittivity). High-k dielectrics are easily polarized by electric fields and are therefore good at storing charge. For this reason, they are not suitable materials for insulation purposes. Instead, low-k dielectrics are better for isolating signal-carrying conductors from one another.

The dielectric materials used to insulate the coil also give rise to dielectric loss. Dielectric loss is the energy that is converted to heat in a dielectric material when it is subjected to an alternating electric field. When the value and direction of the electric field change, the dielectric polarization also changes in value and direction. As the molecules or ions making up the dielectric material are oriented/displaced by the field, they collide with one another dissipating energy. However, the molecules or ions have a specific relaxation time (i.e. the time it takes them to align with the field). If the relaxation time is far greater than the period of the alternating field, the polarization is unable to keep up with the field and the dielectric losses are small. At low frequencies when the relaxation time is considerably less than the period of the alternating field, the polarisation follows the field. At these frequencies the dielectric loss is also small because the number of reorientations per unit time is low. The dielectric loss is highest when T=2πt, where T is the period of the alternating electric field and t is the relaxation time.

There will now be described an apparatus and associated methods that may or may not overcome one or more of these issues.

The present apparatus (as shown in FIG. 4) incorporates a composite material 409 comprising a plurality of magnetic particles 410 dispersed within a dielectric binder 411. The material 409 may be used to coat (all or part of) the coil of the inductor, and/or may be used to form (all or part of) the core around which the coil is wound. As with the core of FIG. 1, the magnetisation of the magnetic particles 410 contributes to the magnetic induction and increases the field strength.

The size of the magnetic particles 410 is key to the performance of the present apparatus, and their mean diameter should be less than 100 nm. The dimensions of the magnetic particles 410 affect performance for two reasons.

First of all, as described with respect to FIGS. 2 and 3, hysteresis is caused by irreversible magnetisation processes associated with domains and domain walls in a ferromagnetic material. The magnetic state of a ferromagnetic material is dictated by the various energy terms of the system (namely exchange energy, magnetocrystalline anisotropy, shape anisotropy, magnetostatic energy, Zeeman energy, and magnetostrictive energy). The material will try to minimise the total energy of the system, but in most cases there will be a large number of different magnetic states that the system can relax into, often with different energies. The lowest energy state is referred to as the ground state, and represents the global minimum. Configurations with higher energy are called metastable states and are the local minima for the system. The configuration supported by a sample depends on the history of the material as well as the applied field strength and direction. Applying a particular field will often change the configuration from one state to another.

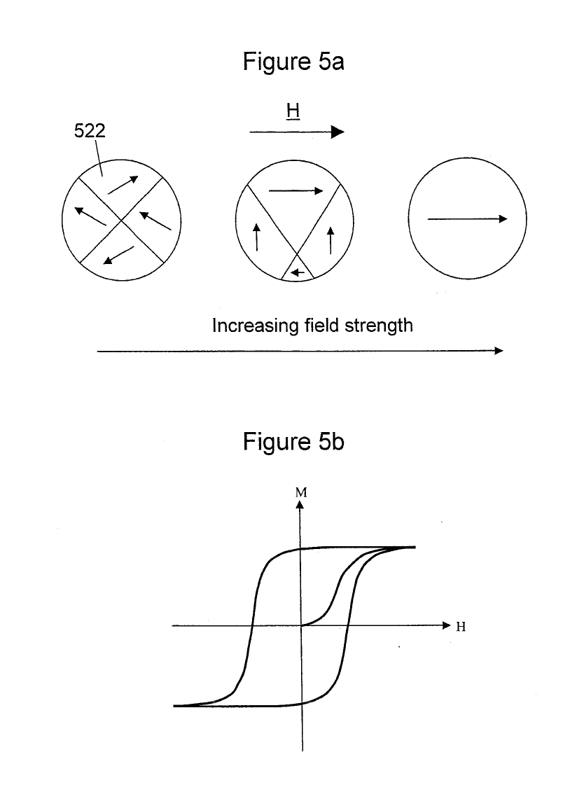

As the dimensions of a particle 410 are reduced in size, the number of different magnetic configurations is also reduced. In general, reducing the dimensions of a particle will decrease the number of domains and domain walls. This can be used to reduce hysteresis energy loss in the system because there is less friction and fewer irreversible steps in the reversal process. FIGS. 5a and 5b show the domain process and hysteresis of a ferromagnetic nanoparticle 522 under the influence of an applied magnetic field, respectively. The domain process and hysteresis loop are similar to that described with reference to FIG. 3.

If the particle size is reduced sufficiently (typically below 20 nm in diameter), the particles 623 will support a single-domain structure comprising no domain walls. At this length-scale, the particle goes from being ferromagnetic to being superparamagnetic. Superparamagnets exhibit magnetic behaviour somewhere between paramagnetic and ferromagnetic materials. In the absence of an applied field, thermal energy is able to switch the magnetisation from one direction to another (i.e. their magnetic orientation is unstable). When an external magnetic field is applied, the magnetisation will align with the field, similar to a paramagnet. Unlike a paramagnet, however, superparamagnetic particles 623 have a large relative magnetic permeability, and are therefore suitable candidates for inductor coils where they can be used to increase the magnetic flux substantially.

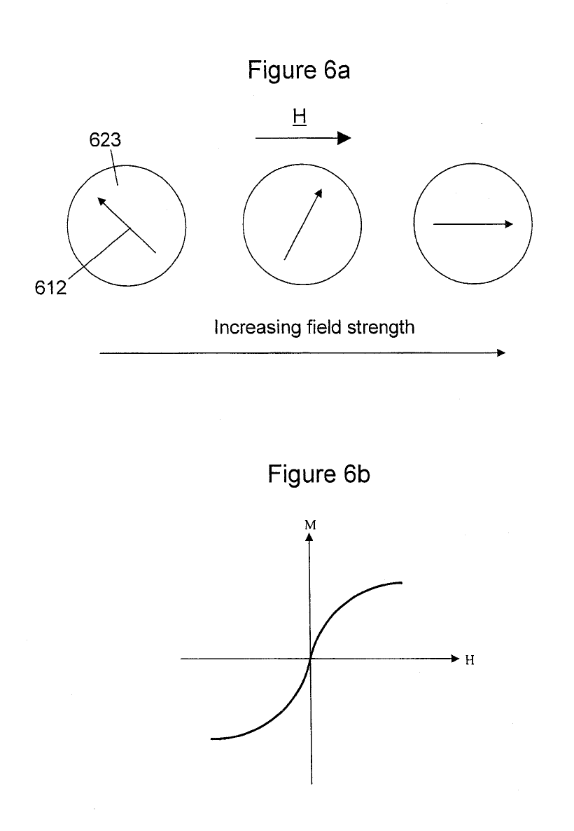

Single-domain particles 623 exhibit uniform magnetisation. During reversal, the magnetisation vector 612 rotates smoothly from one direction to the other via coherent reversal rather than domain wall nucleation and movement. FIGS. 6a and 6b show the domain process and hysteresis of a superparamagnetic nanoparticle 623 under the influence of an applied magnetic field, respectively. As can be seen from FIG. 6b, superparamagnetic particles 623 have a non-hysteretic M-H curve with zero remanence and coercivity.

The dimensions of the magnetic particles also affect the performance of the present apparatus by helping to reduce eddy currents in the magnetic material. As mentioned previously, eddy currents are the circulating loops of electrical current induced in conductive metal cores by the changing magnetic field. These currents dissipate energy as heat in the resistance of the core material, and the amount of energy lost increases with the area inside the loop of current. One method which has previously been used to minimise eddy currents is to use a non-conductive magnetic material like ferrite, but this limits the choice of available materials. By decreasing the dimensions of the magnetic particles, any current loops induced in the particles are confined within the particle boundaries. This reduces the area of the current loops and the associated energy losses considerably.

The magnetic particles may comprise any ferromagnetic or superparamagnetic material (e.g. metals such as Fe, Co or Ni, alloys such as FePt or NiFe, and oxides such as Fe₃O₄), but specific applications may have particular requirements. For this reason, it is important to know the characteristics of each material. The size of the magnetic particles used in the composite material depends on the material chosen. The magnetic properties of a material are determined by quantum mechanics, and in particular, by the anisotropy energy. The anisotropy energy (magnetocrystailine and shape anisotropy) defines the minimum size of a magnetic domain. If the minimum size is larger than the particle size, the magnetic particle will exhibit a single-domain structure. However, for a given material, the critical particle size varies with crystallographic structure (phase): hexagonal close-packed Co has a critical size of 15 nm, whilst face-centred cubic Co has a critical size of only 7 nm. The critical particle size also varies from one material to the next: the critical size of Ni is about 55 nm, whilst for Fe₃O₄, it is about 128 nm. Other factors which affect the critical particle size include temperature, the purity of the particle, and the existence/amount of dislocations, interstitials, vacancies, and grain boundaries.

The relative magnetic permeability of a magnetic material is also based on the quantum mechanical properties of the material, and varies from one material to another. This will also influence the choice of material.

As mentioned previously, parasitic capacitance and dielectric loss further affect the performance of an inductor. The choice of dielectric binder (within which the magnetic particles are contained) is therefore an important consideration. To minimise parasitic capacitance, a material with a low dielectric permittivity is required. To minimise dielectric loss, on the other hand, materials comprising non-polar molecules and uncharged species are preferable over materials comprising polar molecules and ionic species. Suitable materials include non-polar polymers such as polystyrene, syndiotactic polystyrene, polyethylene, polypropylene, cyclic olefin copolymer, polyisobutylene, polyisoprene, polybutadiene, polytetrafluoroethylene, fluorinated ethylene propylene, polyvinylidene fluoride, and any copolymer or polymer blend comprising the monomers of these polymers.

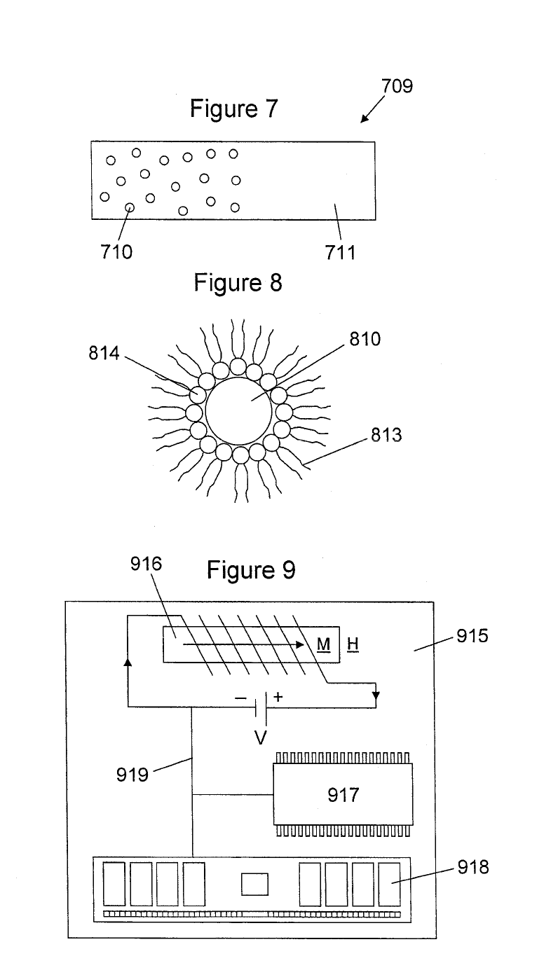

The distribution of the magnetic particles 710 within the dielectric binder 711 may be controlled to some extend by applying a magnetic field to move the magnetic particles 710 within the dielectric binder 711. In this way, it is possible to create a concentration gradient of magnetic particles 710. For example, if we take a piece of composite material 709 as shown in FIG. 4, and apply a magnetic field (field direction right to left), the magnetic particles 710 will migrate towards the left hand side of the material 709 resulting in a concentration gradient within the dielectric binder 711, as shown in FIG. 7. The presence of such a concentration gradient can result in the material 709 exhibiting non-uniform electrical and/or mechanical properties throughout the bulk of the material 709, which may be advantageous for certain applications. Once the desired concentration gradient has been obtained, the dielectric binder 711 can be cured to fix the position of the magnetic particles 710.

On the other hand, it may be desirable to maintain a substantially uniform concentration of magnetic particles 810. In this scenario, surfactant molecules 813 can be added to the composite material to reduce the mobility of the magnetic particles 810 within the dielectric binder. The surfactant molecules 813 may comprise a head group (such as an amine, carboxylic acid, or silane group) configured to adsorb onto the surface of the magnetic particles 810 (as shown in FIG. 8), and may interact with the dielectric material via Van der Waals forces, electrostatic forces, and/or covalent binding. This technique avoids the need to cure the dielectric binder.

It should be noted that the apparatus is not limited for use with magnetic particles that are uniform with respect to composition and/or size, as in some applications of interest it may be desirable to provide mixtures of magnetic particles comprised of different metals/alloys/oxides of the same approximate size, or of different sizes, thereby enabling even further control over the resulting physical and/or electromagnetic properties of the resulting composite material. Further in this regard, the different types of particles may be uniformly mixed together within the dielectric binder, they may be physically segregated within the dielectric binder, or a graded composition of two or more types of particle may be employed (as one non-limiting example, Co particles within one portion of the volume of the dielectric binder, Fe particles within another portion of the volume of the dielectric binder, and an intervening portion of the dielectric binder containing both Co and Fe particles). In addition, it should be appreciated that the magnetic particles may be provided with dimensions such that some portion of the population of magnetic particles exhibits ferromagnetism, while another portion of the population exhibits superparamagnetism. It should also be noted that the composite material is not limited to a single type of dielectric, but may comprise a plurality of different dielectric materials. Furthermore, in a given composite material, there may be some particles that include surfactants, and other particles that either do not include surfactants, or that include a different type of surfactant providing a different type of interaction with the dielectric material. In addition, the apparatus may comprise one or more layers of composite material. Where multiple layers are used, each layer may comprise the same or different magnetic particles and/or dielectric binder.

FIG. 9 illustrates schematically a device 915 comprising the apparatus 916 described herein. The device 915 also comprises a processor 917 and a storage medium 918, which may be electrically connected to one another by a data bus 919. The device 915 may be an electronic device, a portable electronic device, a portable telecommunications device, or a module for any of the aforementioned devices.

Whilst the apparatus 916 has been described herein as an inductor, it could also be a transformer, an electromagnet, a balun, an unun, a choke, or any other multiwinding magnetic component. In addition, the coil and core of the apparatus 916 may be three-dimensional or two dimensional (i.e. a planar coil and core fabricated directly onto a printed circuit board). Using the composite material described herein, the apparatus 916 may, at the frequency of interest, exhibit one or more of the following: a relative magnetic permeability of no less than 1.0, a loss tangent of relative magnetic permeability of no greater than 0.1, a relative dielectric permittivity of no greater than 4.0, and a loss tangent of relative permittivity of no greater than 0.1.

In this way, a smaller coil incorporating the composite material may have the same inductance (and field strength) as a larger coil that does not incorporate the composite material. Furthermore, this performance can be achieved without an increase in loss. In some cases, depending on the specific material chosen, the smaller coil may even exhibit lower loss than the larger coil. The reduction in coil length can be calculated by L=L₀/\sqrt{μ∈}, where L is the inductance of the coil with the composite material, L₀ is the inductance of the same coil without the composite material, and μ and ∈ are the magnetic permeability and dielectric permittivity of the composite material, respectively. If a composite material with μ=1.6 and ∈=3.3 is used, this equation predicts that the length of the coil can be reduced by 56%.

The processor 917 is configured for general operation of the apparatus 916 by providing signalling to, and receiving signalling from, the other device components to manage their operation. The processor 917 is also configured to perform, control or enable the flow of electrical current through the coil to generate a magnetic field.

The storage medium 918 is configured to store computer code configured to perform, control or enable the making and/or operation of the apparatus 916, as described with reference to FIG. 12. The storage medium 918 may also be configured to store settings for the other device components. The processor 917 may access the storage medium 918 to retrieve the component settings in order to manage the operation of the other device components. In particular, the storage medium 918 may comprise a list of current and voltage settings in order to generate different strengths of magnetic field. The storage medium 918 may be a temporary storage medium such as a volatile random access memory. On the other hand, the storage medium 918 may be a permanent storage medium such as a hard disk drive, a flash memory, or a non-volatile random access memory.

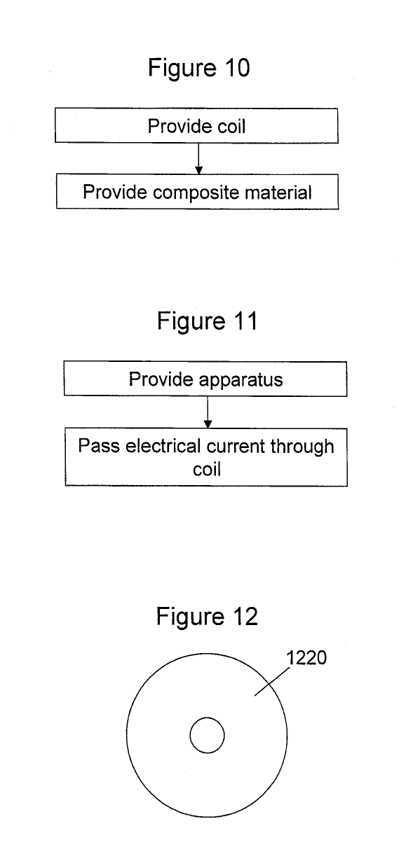

The main steps of the method used to make the apparatus 916 are illustrated schematically in FIG. 10. Likewise, the main steps of the method used to operate the apparatus 916 are illustrated schematically in FIG. 11.

FIG. 12 illustrates schematically a computer/processor readable medium 1220 providing a computer program according to one embodiment. In this example, the computer/processor readable medium 1220 is a disc such as a digital versatile disc (DVD) or a compact disc (CD). In other embodiments, the computer/processor readable medium 1220 may be any medium that has been programmed in such a way as to carry out an inventive function. The computer/processor readable medium 1220 may be a removable memory device such as a memory stick or memory card (SD, mini SD or micro SD).

The computer program may comprise computer code configured to perform, control or enable one or more of the following: the provision of a coil of electrically conducting material configured to generate a magnetic field when an electrical current is passed through the coil; and the provision of a composite material configured to increase the strength of the magnetic field, the composite material comprising a plurality of magnetic particles having a mean diameter of less than 100 nm dispersed within a dielectric binder.

The computer program may also comprise computer code configured to perform, control or enable one or more of the following: the provision of an apparatus, the apparatus comprising a coil of electrically conducting material configured to generate a magnetic field when an electrical current is passed through the coil, and a composite material configured to increase the strength of the magnetic field, the composite material comprising a plurality of magnetic particles having a mean diameter of less than 100 nm dispersed within a dielectric binder; and the passing of an electrical current through the coil.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising a coil configured to allow a flow of electrical current therethrough to generate a magnetic field, and a composite material configured to increase the strength of the magnetic field relative to that which could be generated by the coil without the composite material, the composite material comprising a plurality of magnetic particles having a mean maximum dimension of less than 100 nm dispersed within a dielectric binder.

2. The apparatus of claim 1, wherein the magnetic particles have a mean maximum dimension of less than or equal to 20 nm.

3. The apparatus of claim 1, wherein the magnetic particles have a mean maximum dimension of between 20 nm and 100 nm exclusive.

4. The apparatus of claim 1, wherein the magnetic particles are ferromagnetic or superparamagnetic particles.

5. The apparatus of claim 1, wherein the magnetic particles comprise one or more of Fe, Co, Ni, FePt and Fe₃O₄.

6. The apparatus of claim 1, wherein the dielectric binder comprises a non-polar polymer.

7. The apparatus of claim 1, wherein the dielectric binder comprises one or more of polystyrene, syndiotactic polystyrene, polyethylene, polypropylene, cyclic olefin copolymer, polyisobutylene, polyisoprene, polybutadiene, polytetrafluoroethylene, fluorinated ethylene propylene, polyvinylidene fluoride, and any copolymer or polymer blend comprising the monomers of these polymers.

8. The apparatus of claim 1, wherein the composite material comprises a surfactant configured to reduce the mobility of the magnetic particles within the dielectric binder.

9. The apparatus of claim 8, wherein the surfactant is configured to interact with the dielectric binder through one or more of Van der Waals forces, electrostatic forces, and covalent binding.

10. The apparatus of claim 8, wherein the surfactant comprises a head group configured to adsorb onto the surface of the magnetic particles.

11. The apparatus of claim 10, wherein the head group comprises an amine, carboxylic acid, or silane group.

12. The apparatus of claim 1, wherein the magnetic particles exhibit a substantially uniform concentration within the dielectric binder.

13. The apparatus of claim 1, wherein the magnetic particles exhibit a concentration gradient within the dielectric binder.

14. The apparatus of claim 1, wherein the apparatus is configured to pass an AC current through the coil at a frequency of interest.

15. The apparatus of claim 1, wherein the frequency of interest is no less than 0.01 GHz.

16. The apparatus of claim 14, wherein, at the frequency of interest, the composite material has one or more of the following: a relative magnetic permeability of no less than 1.0, a loss tangent of relative magnetic permeability of no greater than 0.1, a relative dielectric permittivity of no greater than 4.0, and a loss tangent of relative permittivity of no greater than 0.1.

17. The apparatus of claim 1, wherein the composite material forms a coating on all or part of the coil.

18. The apparatus of claim 1, wherein the composite material forms a core around which the coil is wound.

19. The apparatus of claim 1, wherein the apparatus is one or more of the following: an inductor, a transformer, an electromagnet, a balun, an unun, a choke, and any other multiwinding magnetic component.

20. A device comprising the apparatus of claim 1.

21. The device of claim 20, wherein the device is one or more of the following: an electronic device, a portable electronic device, a portable telecommunications device, and a module for any of the aforementioned devices.

22. A method of making an apparatus, the method comprising:
providing a coil configured to allow a flow of electrical current therethrough to generate a magnetic field; and
providing a composite material configured to increase the strength of the magnetic field relative to that which could be generated by the coil without the composite material, the composite material comprising a plurality of magnetic particles having a mean maximum dimension of less than 100 nm dispersed within a dielectric binder.

23. A method of generating a magnetic field, the method comprising:
providing an apparatus, the apparatus comprising a coil configured to allow a flow of electrical current therethrough to generate a magnetic field, and a composite material configured to increase the strength of the magnetic field relative to that which could be generated by the coil without the composite material, the composite material comprising a plurality of magnetic particles having a mean maximum dimension of less than 100 nm dispersed within a dielectric binder; and
passing an electrical current through the coil.

24. A computer program, recorded on a carrier, the computer program comprising computer code configured to perform the method of claim 22.

25. A computer program, recorded on a carrier, the computer program comprising computer code configured to perform the method of claim 23.
